(19) United States
(12) Patent Application Publication
(10) Pub. No.: US 2026/0147376 A1
(43) Pub. Date: May 28, 2026

(54) CHIP AND ELECTRONIC DEVICE

(71) Applicant: Black Sesame Technologies Co., Ltd., Wuhan (CN)

(72) Inventors: Qifan Chen, Chengdu (CN); Hongyuan Zhang, Chengdu (CN); Ziwen Hu, Chengdu (CN)

(73) Assignee: Black Sesame Technologies Co., Ltd., Wuhan (CN)

(21) Appl. No.: 19/395,839

(22) Filed: Nov. 20, 2025

(30) Foreign Application Priority Data
Nov. 22, 2024 (CN) 202411690393.3

(51) Int. Cl. G06F 1/12; G06F 1/14

(52) U.S. Cl. CPC G06F 1/12; G06F 1/14

(57) ABSTRACT

A chip and an electronic device are provided, including: an on-chip clock subsystem configured to transmit a PPS signal to a global time base counting subsystem and output a start time of the PPS signal to a plurality of subsystems; the global time base counting subsystem configured to: forward the PPS signal to a first-category subsystem; and/or obtain a first time when the PPS signal is received and provide a second time for an other-category subsystem to perform synchronization correction of system time; the first-category subsystem configured to perform synchronization correction of its own system time based on the start time of the PPS signal and a first local time when the PPS signal is received; and the other-category subsystem configured to perform synchronization correction of its own system time based on the start time of the PPS signal, the first time, and the second time.

### RELATED APPLICATION

This application claims the benefit under 35 U.S.C. § 119(a) of the filing date of Chinese Patent Application No. 202411690393.3, filed in the Chinese Patent Office on Nov. 22, 2024. The disclosure of the foregoing application is herein incorporated by reference in its entirety.

### TECHNICAL FIELD

The present disclosure relates to a chip technology field, and more particularly, to a chip and an electronic device.

### BACKGROUND

An Advanced Driving Assistance System (ADAS) utilizes various categories of subsystems (such as a lidar, a millimeter-wave radar, a camera, or a satellite positioning device) installed on a vehicle to acquire real-time data on the surrounding environment while the vehicle is in motion, identify, detect, and track dynamic and static objects, and perform systematic calculations and analysis in combination with navigation map data, allowing a driver to be aware of potential dangers in the shortest time in advance, thereby improving driving safety.

After acquiring corresponding data, each of the various categories of subsystems records a timestamp of an acquisition moment of the data. A processing unit then integrates the timestamps to restore surrounding environment data of the vehicle. Therefore, maintaining high temporal consistency between subsystems is a prerequisite for multi-subsystem data fusion.

In existing techniques, accuracy of time synchronization between different subsystems within a chip is relatively low.

### SUMMARY

Embodiments of the present disclosure at least provide a chip, where different subsystems in the chip synchronize system time with an on-chip clock subsystem respectively, thereby reducing a number of peripherals required to achieve time synchronization and improving accuracy of time synchronization of different subsystems.

In an embodiment of the present disclosure, a chip is provided, including an on-chip clock subsystem, a global time base counting subsystem, and a plurality of subsystems, where the plurality of subsystems include at least one of the following: a first-category subsystem and an other-category subsystem; where the on-chip clock subsystem is configured to transmit a Pulse Per Second (PPS) signal to the global time base counting subsystem, and output a start time of the PPS signal to the plurality of subsystems; the global time base counting subsystem is configured to: forward the PPS signal to the first-category subsystem; and/or obtain a first time when the PPS signal is received, and provide a second time for the other-category subsystem to perform synchronization correction of system time; the first-category subsystem and the other-category subsystem all use the PPS signal as a synchronization trigger source; the first-category subsystem is configured to perform synchronization correction of its own system time based on the start time of the PPS signal and a first local time when the PPS signal is received, and has the ability to receive the PPS signal; and the other-category subsystem is configured to perform synchronization correction of its own system time based on the start time of the PPS signal, the first time and the second time.

From above, the on-chip clock subsystem outputs the PPS signal, which serves as a synchronization trigger source for each subsystem within the chip. The global time base counting subsystem forwards the PPS signal to the first-category subsystem. The first-category subsystem performs synchronization correction of its own system time based on the start time of the PPS signal and the first local time when the PPS signal is received. Alternatively, the global time base counting subsystem provides the first time and the second time, enabling the other-category subsystem to perform synchronization correction of its own system time. This allows different subsystems to synchronize their system time with the on-chip clock subsystem, improving accuracy and flexibility of clock synchronization within the chip.

Optionally, the global time base counting subsystem includes at least one of the following: a gate module, a local latch module, and a global time base counting module; where the gate module is configured to receive the PPS signal and forward the PPS signal to the first-category subsystem; the local latch module is configured to latch a first count value, where the first count value represents the first time, and the first count value is a count value of the global time base counting module when the global time base counting subsystem receives the PPS signal; and the global time base counting module is configured to count based on a preset frequency.

Optionally, the first-category subsystem includes: a PPS receiving module, a first inter-core communication module, and a first time correction module; where the PPS receiving module is configured to receive the PPS signal transmitted by the on-chip clock subsystem and latch the first local time when the PPS signal is received; the first inter-core communication module is coupled to the on-chip clock subsystem and is configured to receive first notification information transmitted by the on-chip clock subsystem, where the first notification information includes the start time of the PPS signal; and the first time correction module is configured to perform synchronization correction of its own system time through a first time correction amount that is associated with the first local time and the start time of the PPS signal.

Optionally, the first time correction amount is further associated with a first error that includes a first PPS signal transmission delay and a first PPS signal reception delay; where the first PPS signal transmission delay is a transmission time of the PPS signal from the on-chip clock subsystem to the first-category subsystem; and the first PPS signal reception delay is a time required from the PPS receiving module receiving the PPS signal to the PPS receiving module capturing the first local time.

Optionally, the first time correction module is configured to correct its own system time using the first time correction amount in response to the first time correction amount being greater than a preset time threshold; and/or in response to the first time correction amount being not greater than the preset time threshold, correcting system time of the first-category subsystem in a successive approximation manner with a fixed time step.

Optionally, the other-category subsystem includes a second-category subsystem, and the second-category subsystem includes: a second inter-core communication module, a local time base counting module, and a second time correction module; where the second inter-core communication module is coupled to the on-chip clock subsystem and is configured to receive second notification information transmitted by the on-chip clock subsystem, where the second notification information includes the start time of the PPS signal and the first time; the local time base counting module is coupled to the global time base counting module, and a count value of the local time base counting module is equal to the count value of the global time base counting module; and the second time correction module is configured to perform synchronization correction of its own system time through a second time correction amount that is associated with the start time of the PPS signal, the first time and the second time, the second time is represented by a second count value of the local time base counting module, and the second count value is the count value of the local time base counting module when the synchronization correction of system time is performed by the second time correction module.

Optionally, the second time correction amount is further associated with a second error that includes a second PPS signal transmission delay, a second PPS signal reception delay, and a first read delay; where the second PPS signal transmission delay is a transmission time of the PPS signal from the on-chip clock subsystem to the global time base counting module; the second PPS signal reception delay is a time required from the global time base counting subsystem receiving the PPS signal to latching the first time; and the first read delay is a time required to read the second count value from the local time base counting module.

Optionally, the global time base counting subsystem further includes: an encoding module, configured to encode the count value output by the global time base counting module and output an encoding result; and the second-category subsystem further includes: a decoding module configured to decode the encoding result to obtain the count value of the global time base counting module.

Optionally, the other-category subsystem includes a third-category subsystem, and the third-category subsystem includes: a third inter-core communication module, a fourth inter-core communication module, and a third time correction module, where the third inter-core communication module is coupled to the on-chip clock subsystem, and is configured to receive second notification information transmitted by the on-chip clock subsystem, where the second notification information includes the start time of the PPS signal and the first time; the fourth inter-core communication module is coupled to the global time base counting module; and the third time correction module is configured to perform synchronization correction of its own system time through a third time correction amount that is associated with the start time of the PPS signal, the first time and the second time, where the second time is determined by a third count value of the global time base counting module, the third count value is a count value obtained from the global time base counting module through the fourth inter-core communication module when the synchronization correction of system time is performed by the third time correction module.

Optionally, the third time correction amount is further associated with a third error that includes a second PPS signal transmission delay, a second PPS signal reception delay, and a second read delay; where the second PPS signal transmission delay is a transmission time of the PPS signal from the on-chip clock subsystem to the global time base counting subsystem; the second PPS signal reception delay is a time required from the global time base counting subsystem receiving the PPS signal to latching the first time; and the second read delay is a time required to read the third count value from the global time base counting module.

In an embodiment of the present disclosure, an electronic device is provided, including any of the above chips.

### BRIEF DESCRIPTION OF THE DRAWINGS

FIG. 1 is a schematic structural diagram of a chip according to an embodiment.

FIG. 2 is a schematic structural diagram of an on-chip clock subsystem according to an embodiment of the present disclosure.

FIG. 3 is a schematic structural diagram of a global time base counting subsystem according to an embodiment of the present disclosure.

FIG. 4 is a schematic diagram of a synchronization process of a first-category subsystem according to an embodiment of the present disclosure.

FIG. 5 is a schematic diagram of a synchronization process of a second-category subsystem according to an embodiment of the present disclosure.

FIG. 6 is a schematic diagram of a synchronization process of a third-category subsystem according to an embodiment of the present disclosure.

### DETAILED DESCRIPTION

In existing technologies, different subsystems within a chip require obtaining external Coordinated Universal Time (UTC). One synchronization approach is to synchronize each subsystem with a corresponding external clock source. This approach significantly increases complexity and cost of the chip, and has high demands on the chip, as it requires a specific external clock source for each subsystem.

Another synchronization approach is to synchronize one subsystem (for example, subsystem A) with an external clock source, allowing the subsystem A to obtain UTC. Other subsystems within the chip then obtain UTC from the subsystem A through inter-core communication, thus achieving time synchronization of different subsystems in the chip. However, when different subsystems communicate with the subsystem A, different transmission delays may occur, resulting in poor accuracy of time synchronization within the chip.

In embodiments of the present disclosure, an on-chip clock subsystem outputs a PPS signal which serves as a synchronization trigger source for each subsystem within a chip. A global time base counting subsystem forwards the PPS signal to a first-category subsystem. The first-category subsystem performs synchronization correction of its own system time based on a start time of the PPS signal and a first local time when the PPS signal is received. Alternatively, the global time base counting subsystem provides a first time and a second time, enabling an other-category subsystem to perform synchronization correction of its own system time. This allows different subsystems to synchronize their system time with the on-chip clock subsystem, improving accuracy and flexibility of clock synchronization within the chip.

In order to clarify the objects, characteristics and advantages of the disclosure, embodiments of present disclosure will be described in detail in conjunction with accompanying drawings.

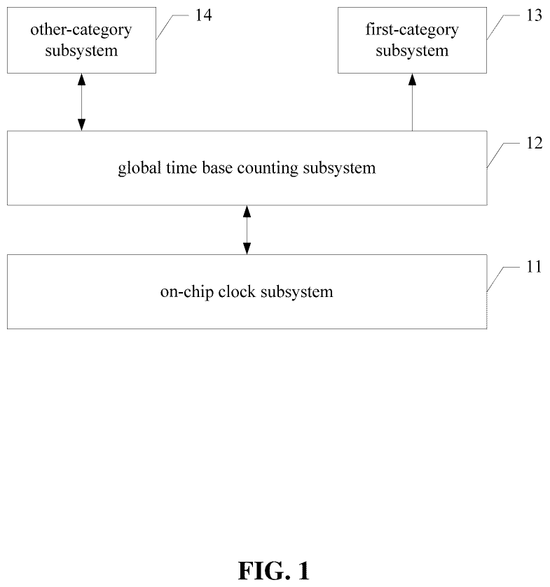

Referring to FIG. 1, an embodiment of the present disclosure provides a chip.

In an embodiment of the present disclosure, a chip may include an on-chip clock subsystem 11, a global time base counting subsystem 12, and a plurality of subsystems. The plurality of subsystems may include a first-category subsystem 13 and an other-category subsystem 14.

The on-chip clock subsystem 11 may generate a PPS signal, transmit the PPS signal to the global time base counting subsystem 12, and output a start time of the PPS signal to the plurality of subsystems.

The global time base counting subsystem 12 may forward the PPS signal to the first-category subsystem 13; and/or obtain a first time when the PPS signal is received, and provide a second time for the other-category subsystem 14 to perform synchronization correction of system time.

The first-category subsystem 13 and the other-category subsystem 14 may both use the PPS signal as a synchronization trigger source.

The first-category subsystem 13 has the ability to directly receive the PPS signal. The first-category subsystem 13 may perform synchronization correction of its own system time based on the start time of the PPS signal and a first local time when the PPS signal is received.

The other-category subsystem 14 may correct its own system time based on the start time of the PPS signal, the first time and the second time.

In a specific implementation, the plurality of subsystems may refer to subsystems within the chip responsible for different functions, such as a subsystem responsible for camera image acquisition, a subsystem responsible for millimeter-wave radar signal acquisition, a subsystem responsible for data fusion operations, or a subsystem responsible for satellite positioning.

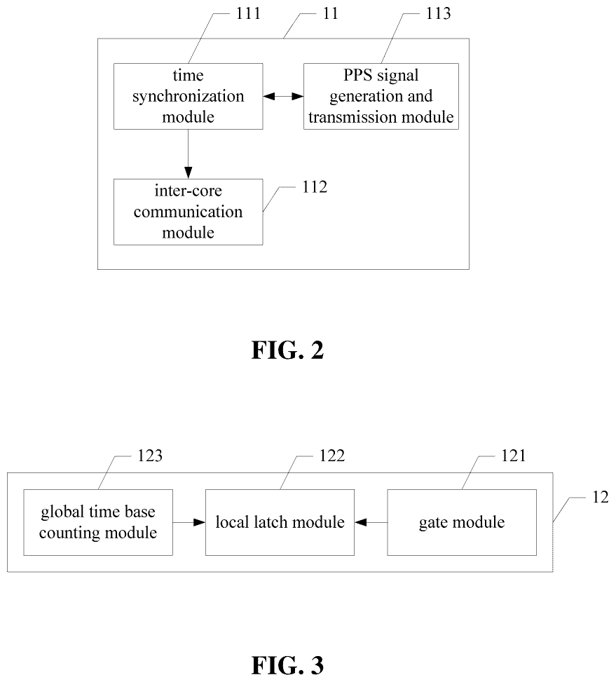

Referring to FIG. 2, a schematic structural diagram of an on-chip clock subsystem according to an embodiment of the present disclosure is provided.

In a specific implementation, the on-chip clock subsystem 11 may include: a time synchronization module 111, an inter-core communication module 112, and a PPS signal generation and transmission module 113.

The time synchronization module 111 communicates with the PPS signal generation and transmission module 113 and the inter-core communication module 112, and is configured to: configure parameters such as the start time, a pulse width, and a period of the PPS signal, and output the start time of the PPS signal to the inter-core communication module 112; or obtain the first time, and output the start time of the PPS signal and the first time to the inter-core communication module 112.

The inter-core communication module 112 may be connected to inter-core communication modules of the plurality of subsystems in the chip to implement inter-core communication with the plurality of subsystems. The inter-core communication module 112 may transmit the start time of the PPS signal to the first-category subsystem, or transmit the start time of the PPS signal and the first time to the other-category subsystem.

The PPS signal generation and transmission module 113 may be configured to generate the PPS signal, and output the generated PPS signal to the global time base counting subsystem 12.

In a specific implementation, the on-chip clock subsystem 11 may synchronize time with an external clock source. Specifically, the on-chip clock subsystem 11 may synchronize time with the external clock source through methods such as Global Navigation Satellite System (GNSS) timing synchronization, Network Time Protocol (NTP) synchronization, or Precision Time Protocol (PTP) synchronization.

Referring to FIG. 3, a schematic structural diagram of a global time-base counting subsystem according to an embodiment of the present disclosure is provided.

In an embodiment of the present disclosure, the global time base counting subsystem 12 may include: a gate module 121, a local latch module 122 and a global time base counting module 123.

The gate module 121 may receive the PPS signal and forward the received PPS signal to the first-category subsystem 13. The gate module 121 may also forward the PPS signal to the local latch module 122. The gate module 121 may include a plurality of output terminals each of which may be coupled to one first-category subsystem 13.

The local latch module 122 may latch a first count value which represents the first time. The first count value may be a count value of the global time base counting module 123 when the global time base counting subsystem 12 receives the PPS signal.

The global time base counting module 123 may count based on a preset frequency.

In a specific implementation, in response to receiving the PPS signal, the global time base counting subsystem 12 may latch the count value of the global time base counting module 123 into the local latch module 122. In this scenario, the count value in the local latch module 122 is the first count value used to represent the first time.

In a specific implementation, the time synchronization module 111 of the on-chip clock subsystem 11 may read the first count value stored in the local latch module 122 to obtain the first time.

In the embodiments of the present disclosure, the first-category subsystem 13 may include one or more subsystems. Different subsystems in the first-category subsystem 13 may be connected to the same on-chip clock subsystem or to different on-chip clock subsystems.

For example, the first-category subsystem 13 includes a subsystem A and a subsystem B, and a PPS signal output by an on-chip clock subsystem G is a synchronization trigger source for the subsystem A and the subsystem B.

For another example, the first-category subsystem includes a subsystem A and a subsystem B. An on-chip clock subsystem G outputs a PPS signal to the subsystem A, and an on-chip clock subsystem F outputs a PPS signal to the subsystem B. The subsystem A uses the PPS signal output by the on-chip clock subsystem G as a synchronization trigger source, and the subsystem B uses the PPS signal output by the on-chip clock subsystem F as a synchronization trigger source. The PPS signal output by the on-chip clock subsystem G and the PPS signal output by the on-chip clock subsystem F have the same frequency.

In some embodiments, the PPS signals output by different on-chip clock subsystems may have different frequencies. For example, the PPS signals output by the on-chip clock subsystem G and the on-chip clock subsystem F have different frequencies.

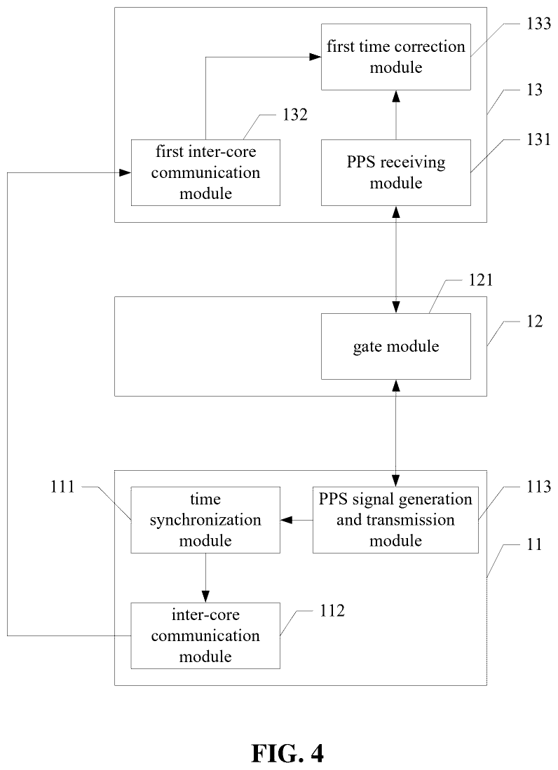

FIG. 4 is a schematic diagram of a synchronization process of a first-category subsystem according to an embodiment of the present disclosure. As being not used during synchronization of the first-category subsystem, the global time base counting module 123 and the local latch module 122 are not shown in FIG. 4.

In the embodiment of the present disclosure, the first-category subsystem 13 may include: a PPS receiving module 131, a first inter-core communication module 132, and a first time correction module 133.

The PPS receiving module 131 is configured to receive the PPS signal forwarded by the gate module 121, and latch a local time when receiving the PPS signal. The latched local time is the first local time when the PPS signal is received. The latched local time can also be understood as a latched system time.

The first inter-core communication module 132 is coupled to the inter-core communication module 112 in the on-chip clock subsystem, and is configured to receive first notification information transmitted by the on-chip clock subsystem, where the first notification information includes the start time of the PPS signal.

The first time correction module 133 is configured to perform synchronization correction of its own system time through a first time correction amount that is associated with the first local time and the start time of the PPS signal.

A synchronization process of the first-category subsystem is described below.

The on-chip clock subsystem 11 generates and transmits a PPS signal via the PPS signal generation and transmission module 113. The PPS signal passes through the gate module 121 and is output to the PPS receiving module 131 of the first-category subsystem 13. After transmitting the PPS signal, the PPS signal generation and transmission module 113 notifies the time synchronization module 111 of the transmission. The time synchronization module 111 transmits the start time of the PPS signal to the first-category subsystem 13 via the inter-core communication module 112.

When receiving the PPS signal, the PPS receiving module 131 of the first-category subsystem 13 may capture the first local time when the PPS signal is received.

The first time correction module 133 of the first-category subsystem 13 receives the first notification information through the first inter-core communication module 132, thereby learning the start time of the PPS signal. The first time correction module 133 determines the first time correction amount based on the first local time and the start time of the PPS signal. Further, the first time correction module 133 performs synchronization correction of its own system time based on the first time correction amount, thereby achieving time synchronization with the on-chip clock subsystem 11.

In a specific implementation, the first time correction amount may be determined using a following formula: Offset=TPT-LPT, where TPT is the start time of the PPS signal, and LPT is the first local time.

In some embodiments, there is a certain transmission delay when the PPS signal is transmitted from the on-chip clock subsystem 11 to the first-category subsystem 13. There is also a certain reception delay between the PPS receiving module 131 detecting the PPS signal to capturing the first local time (that is, obtaining the first count value). The transmission delay and the reception delay affect the first time correction amount.

To improve accuracy of time synchronization, a first error may be introduced into the first time correction amount. The first error is a sum of a first PPS signal transmission delay and a first PPS signal reception delay. The first PPS signal transmission delay may refer to the time required for the PPS signal to be transmitted from the on-chip clock subsystem 11 to the first-category subsystem 13. The first PPS signal reception delay may refer to the time required by the PPS receiving module 131 from receiving the PPS signal to capturing the first local time.

With the first error being introduced, the first time correction amount may be determined as: Offset=TPT-LPT+first error.

In a specific implementation, the first PPS signal transmission delay and the first PPS signal reception delay may be known in advance. To calculate the first time correction amount, the first PPS signal transmission delay and the first PPS signal reception delay may be directly used to obtain the first error.

In a specific implementation, if the first time correction amount obtained for the first-category subsystem 13 is relatively large, it means that the system time of the first-category subsystem 13 has a large time offset, and time synchronization needs to be achieved as soon as possible. In this scenario, the first time correction module 133 may directly correct the system time based on the first time correction amount, thereby realizing rapid time synchronization. However, as the system time is directly corrected based on the first time correction amount, the system time may have a sudden change.

If the obtained first time correction amount is small, it means that the system time of the first-category subsystem 13 has a small time offset. To avoid a sudden change in the system time of the first-category subsystem 13, the system time of the on-chip clock subsystem 11 may be gradually approached by adjusting steps.

For example, within a synchronization period, the system time of the first-category subsystem 13 is adjusted in a fixed time step, so that the system time of the first-category subsystem 13 gradually approaches the system time of the on-chip clock subsystem 11.

In an embodiment of the present disclosure, the other-category subsystem 14 may include a second-category subsystem 141. The second-category subsystem 141 may be a subsystem that supports external count value input. In some embodiments, the second-category subsystem 141 may not support reception of a PPS signal.

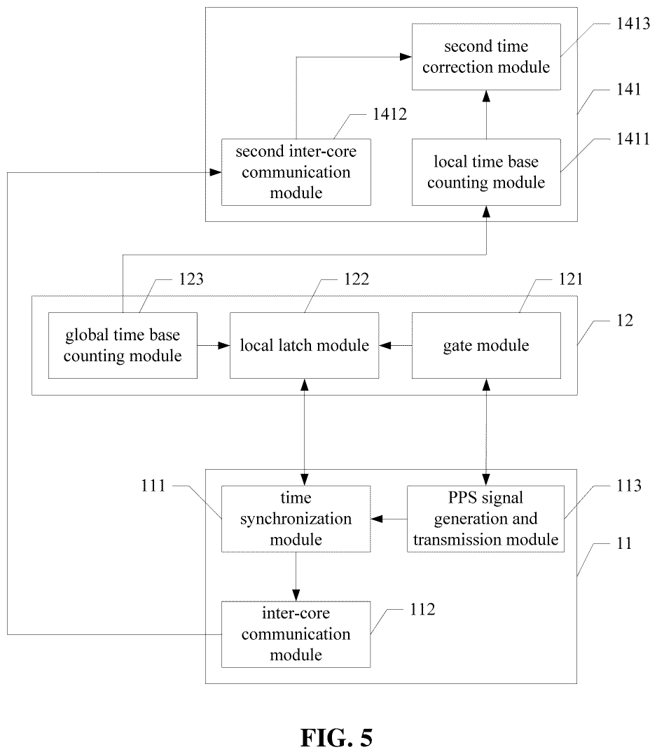

FIG. 5 is a schematic diagram of a synchronization process of a second-category subsystem according to an embodiment of the present disclosure.

In a specific implementation, the second-category subsystem 141 includes: a local time base counting module 1411, a second inter-core communication module 1412, and a second time correction module 1413.

The second inter-core communication module 1412 is coupled to the on-chip clock subsystem 11, and is configured to receive second notification information transmitted by the on-chip clock subsystem 11, where the second notification information includes the start time of the PPS signal and the first time.

The local time base counting module 1411 is coupled to the global time base counting module 123, and a count value of the local time base counting module 1411 is equal to the count value of the global time base counting module 123.

The second time correction module 1413 is configured to determine a second time correction amount, and perform synchronization correction of its own system time through the second time correction amount.

Specifically, the second inter-core communication module 1412 may perform inter-core communication with the inter-core communication module 112 of the on-chip clock subsystem 11 to receive the second notification information transmitted by the on-chip clock subsystem 11.

In a specific implementation, the global time base counting subsystem may further include an encoding module configured to encode the count value output by the global time base counting module. Accordingly, the second-category subsystem may further include a decoding module configured to decode the encoded count value to obtain the count value output by the global time base counting module 123.

By providing the encoding module in the global time base counting subsystem to encode the count value output by the global time base counting module, errors can be avoided during transmission across asynchronous systems (that is, clock sources and frequencies of the global time base counting subsystem and the second-category subsystem are different).

A synchronization process of the second-category subsystem 141 is described below.

The on-chip clock subsystem 11 configures parameters such as the start time, a pulse width, and a period of the PPS signal through the time synchronization module 111, and outputs the start time of the PPS signal to the inter-core communication module 112. The PPS signal generation and transmission module 113 generates and transmits the corresponding PPS signal based on the parameters configured by the time synchronization module 111. After transmitting the PPS signal, the PPS signal generation and transmission module 113 may notify the time synchronization module 111 that the PPS signal has been transmitted.

In response to receiving the PPS signal, the global time base counting subsystem 12 latches the first count value of the global time base counting module 123 at the time of receiving the PPS signal. The first count value represents the first time. The first count value is latched in the local latch module 122. After latching the first count value, the local latch module 122 may communicate with the time synchronization module 111 of the on-chip clock subsystem 11 to notify the time synchronization module 111 to obtain the first count value.

The time synchronization module 111 reads the latched first count value from the local latch module 122 to obtain the first time. The time synchronization module 111 transmits a second notification information to the second inter-core communication module 1412 of the second-category subsystem 141 via the inter-core communication module 112. The second notification information includes the first time (represented by the first count value GLC) and the start time TPT of the PPS signal.

The second time correction module 1413 calculates the second time correction amount based on the first time, the start time of the PPS signal, and the second time at which synchronization correction of system time is performed. After obtaining the second time correction amount, the second time correction module 1413 performs synchronization correction of its own system time, thereby achieving time synchronization with the on-chip clock subsystem 11. The second time may be represented by the second count value of the local time base counting module 1411. The second count value may be the count value of the local time base counting module 1411 when synchronization correction of system time is performed.

In the embodiment of the present disclosure, the second time is the count value of the local time base counting module 1411 when the second time correction module 1413 starts to perform synchronization correction of system time. In other words, the second time is after the second time correction module 1413 receives the second notification information.

The second time correction module 1413 may have a corresponding software program run therein to perform synchronization correction of system time. Therefore, the second time mentioned above may also be understood as the count value of the local time base counting module 1411 when the software program starts to perform synchronization correction of system time.

Specifically, the second time correction amount may be:
Offset=TPT+(Current Local Counter Value−GLC)/GTC frequency, where TPT is the start time of the PPS signal, Current Local Counter Value is the second count value, i.e., the count value of the local time base counting module 1411 when synchronization correction of system time is performed, which is used to represent the second time, GLC is the first count value of the global time base counting module 123, which is used to represent the first time, and GTC frequency is a frequency of the global time base counting module 123.

In a specific implementation, the second time correction amount may be corrected using a second error. The second error may include following parts: a second PPS signal transmission delay, a second PPS signal reception delay, and a first read delay. The second PPS signal transmission delay is a transmission time of the PPS signal from the on-chip clock subsystem 11 to the global time base counting subsystem 12. The second PPS signal reception delay is a time required from the global time base counting subsystem 12 receiving the PPS signal to capturing the first count value (i.e., latching the first time). The first read delay is a time required to read the second count value from the local time base counting module 1411.

Therefore, the second time correction amount may be updated as follows:
Offset=TPT+(Current Local Counter Value−GLC)/GTC frequency+second error.

After obtaining the updated second time correction amount, time synchronization may be performed based on the updated second time correction amount.

In the embodiments of the present disclosure, the other-category subsystem 14 may include a third-category subsystem that does not support reception of a PPS signal and input of an external count value.

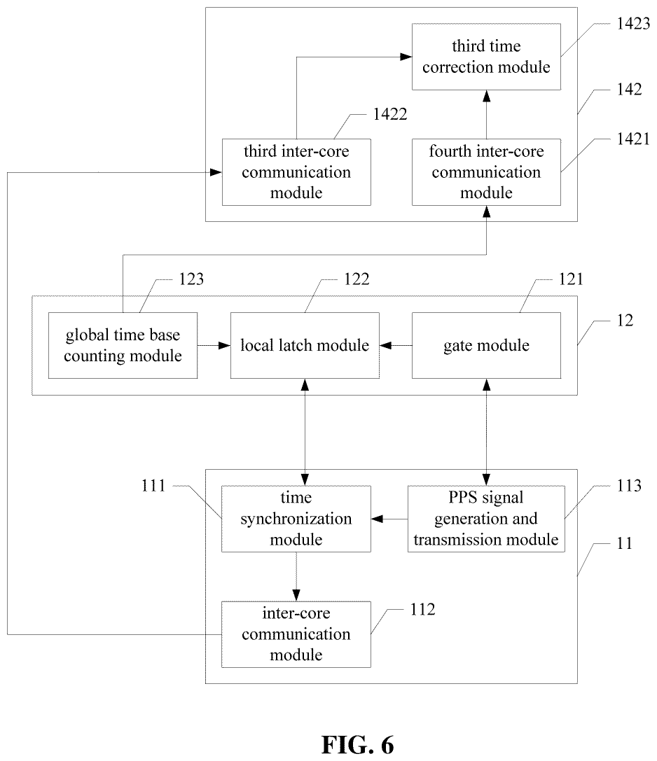

Referring to FIG. 6, FIG. 6 is a schematic diagram of a synchronization process of a third-category subsystem according to an embodiment of the present disclosure.

In a specific implementation, the third-category subsystem 142 may include: a third inter-core communication module 1422, a fourth inter-core communication module 1421, and a third time correction module 1423.

The third inter-core communication module 1422 is coupled to the on-chip clock subsystem 11, and is configured to receive second notification information transmitted by the on-chip clock subsystem 11, where the second notification information includes the start time of the PPS signal and the first time.

The fourth inter-core communication module 1421 is coupled to the global time base counting module 123. The third time correction module 1423 is configured to obtain a third count value of the global time base counting module 123 through the fourth inter-core communication module 1421 and determine the second time based on the third count value.

The third time correction module 1423 is configured to perform synchronization correction of its own system time using a third time correction amount that is associated with the start time of the PPS signal, the first time, and the second time.

A synchronization process of the third-category subsystem 142 is described below.

The on-chip clock subsystem 11 generates and transmits the PPS signal through the PPS signal generation and transmission module 113. After transmitting the PPS signal, the PPS signal generation and transmission module 113 may notify the time synchronization module 111 that the PPS signal has been transmitted.

In response to receiving the PPS signal, the global time base counting subsystem 12 latches the first count value of the global time base counting module 123 at the time of receiving the PPS signal. The first count value represents the first time. The first count value is latched in the local latch module 122. After latching the first count value, the local latch module 122 may communicate with the time synchronization module 111 of the on-chip clock subsystem 11 to notify the time synchronization module 111 to obtain the first count value.

The time synchronization module 111 reads the latched first count value from the local latch module 122 to obtain the first time. The time synchronization module 111 transmits the second notification information to the third inter-core communication module 1422 of the third-category subsystem 142 via the inter-core communication module 112. The second notification information includes the first time (represented by the first count value GLC) and the start time TPT of the PPS signal.

The third time correction module 1423 calculates the third time correction amount based on the first time, the start time of the PPS signal, and the second time when synchronization correction of system time is performed. The second time may be represented by a third count value which may be the count value of the global time base counting module 123 when synchronization correction of system time is performed.

In the embodiments of the present disclosure, the third time correction module 1423 may have a corresponding software program run therein to perform synchronization correction of system time. Therefore, the second time mentioned above may be understood as the count value of the global time base counting module 123 when the software program starts to perform synchronization correction of system time.

Specifically, the third time correction amount may be:
Offset=TPT+(Current GTC Counter Value−GLC)/GTC frequency, where TPT is the start time of the PPS signal, Current GTC Counter Value is the third count value, i.e., the count value of the global time base counting module 123 when synchronization correction of system time is performed, which is used to represent the second time, GLC is the first count value of the global time base counting module 123, which is used to represent the first time, and GTC frequency is a frequency of the global time base counting module 123.

In a specific implementation, the third time correction amount may be corrected using a third error. The third error may include following parts: a second PPS signal transmission delay, a second PPS signal reception delay, and a second read delay. The second PPS signal transmission delay is a transmission time of the PPS signal from the on-chip clock subsystem 11 to the global time base counting subsystem 12. The second PPS signal reception delay is a time required from the global time base counting subsystem 12 receiving the PPS signal to capturing the first count value (i.e., latching the first time). The second read delay is a time required to read the third count value from the global time base counting module 123.

Therefore, the third time correction amount may be updated as follows, Offset=TPT+(Current GTC Counter Value−GLC)/GTC frequency+third error.

After obtaining the updated third time correction amount, time synchronization may be performed based on the updated third time correction amount.

In the embodiments of the present disclosure, among the first-category, second-category and third-category subsystems, synchronization accuracy of the first-category subsystem is the highest, synchronization accuracy of the second-category subsystem is the second highest, and synchronization accuracy of the third-category subsystem is the lowest.

A synchronization error of the first-category subsystem is mainly caused by a hardware transmission delay within the chip, such as the time required for the PPS signal to be transmitted from the on-chip clock subsystem to the first-category subsystem. The hardware transmission delay may be compensated by introducing the first error.

A synchronization error of the second-category subsystem is mainly caused by a hardware transmission delay within the chip (such as the time required for the PPS signal to be transmitted from the on-chip clock subsystem to the global time base counting subsystem) and a read delay of reading the second count value from the local time base counting module. The hardware transmission delay and the read delay may be compensated by introducing the second error.

A synchronization error in the third-category subsystem is mainly caused by a hardware transmission delay within the chip (such as the time required for the PPS signal to be transmitted from the on-chip clock subsystem to the global time base counting subsystem) and a read delay of reading the second count value from the global time base counting module. The hardware transmission delay and the read delay may be compensated by introducing the third error. As the second count value is read across subsystems (the third-category subsystem reads the second count value from the global time base counting subsystem), the corresponding delay of the third-category subsystem is longer than that of the second-category subsystem.

In some application scenarios, the synchronization accuracy of the first-category subsystem can reach tens of nanoseconds, the synchronization accuracy of the second-category subsystem can reach hundreds of nanoseconds, and the synchronization accuracy of the third-category subsystem can reach hundreds of microseconds.

In summary, the chip provided in the embodiments of the present disclosure, through its internal clock subsystem and global time base counting subsystem, can achieve time synchronization for subsystems of different categories and capabilities. Further, by applying the time synchronization solution provided in the above embodiments to the subsystems of different categories and capabilities, synchronization errors may be reduced, synchronization accuracy may be improved, and inter-core communication load may be reduced.

An embodiment of the present disclosure further provides an electronic device, including the chip provided by any of the above embodiments.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A chip, comprising:
an on-chip clock subsystem, a global time base counting subsystem, and a plurality of subsystems, wherein the plurality of subsystems comprise at least one of the following: a first-category subsystem and an other-category subsystem;
wherein the on-chip clock subsystem is configured to transmit a Pulse Per Second (PPS) signal to the global time base counting subsystem, and output a start time of the PPS signal to the plurality of subsystems;
the global time base counting subsystem is configured to: forward the PPS signal to the first-category subsystem; and/or obtain a first time when the PPS signal is received, and provide a second time for the other-category subsystem to perform synchronization correction of system time;
the first-category subsystem and the other-category subsystem all use the PPS signal as a synchronization trigger source;
the first-category subsystem is configured to perform synchronization correction of its own system time based on the start time of the PPS signal and a first local time when the PPS signal is received, and has the ability to receive the PPS signal; and
the other-category subsystem is configured to perform synchronization correction of its own system time based on the start time of the PPS signal, the first time and the second time.

2. The chip according to claim 1, wherein the global time base counting subsystem comprises at least one of the following: a gate module, a local latch module, and a global time base counting module;
wherein the gate module is configured to receive the PPS signal and forward the PPS signal to the first-category subsystem;
the local latch module is configured to latch a first count value, wherein the first count value represents the first time, and the first count value is a count value of the global time base counting module when the global time base counting subsystem receives the PPS signal; and
the global time base counting module is configured to count based on a preset frequency.

3. The chip according to claim 1, wherein the first-category subsystem comprises: a PPS receiving module, a first inter-core communication module, and a first time correction module;
wherein the PPS receiving module is configured to receive the PPS signal transmitted by the on-chip clock subsystem and latch the first local time when the PPS signal is received;
the first inter-core communication module is coupled to the on-chip clock subsystem and is configured to receive first notification information transmitted by the on-chip clock subsystem, wherein the first notification information comprises the start time of the PPS signal; and
the first time correction module is configured to perform synchronization correction of its own system time through a first time correction amount that is associated with the first local time and the start time of the PPS signal.

4. The chip according to claim 3, wherein the first time correction amount is further associated with a first error that comprises a first PPS signal transmission delay and a first PPS signal reception delay;
wherein the first PPS signal transmission delay is a transmission time of the PPS signal from the on-chip clock subsystem to the first-category subsystem; and
the first PPS signal reception delay is a time required from the PPS receiving module receiving the PPS signal to the PPS receiving module capturing the first local time.

5. The chip according to claim 3, wherein the first time correction module is configured to correct its own system time using the first time correction amount in response to the first time correction amount being greater than a preset time threshold; and/or
in response to the first time correction amount being not greater than the preset time threshold, correcting system time of the first-category subsystem in a successive approximation manner with a fixed time step.

6. The chip according to claim 2, wherein the other-category subsystem comprises a second-category subsystem, and the second-category subsystem comprises: a second inter-core communication module, a local time base counting module, and a second time correction module;
wherein the second inter-core communication module is coupled to the on-chip clock subsystem and is configured to receive second notification information transmitted by the on-chip clock subsystem, wherein the second notification information comprises the start time of the PPS signal and the first time;
the local time base counting module is coupled to the global time base counting module, and a count value of the local time base counting module is equal to the count value of the global time base counting module; and
the second time correction module is configured to perform synchronization correction of its own system time through a second time correction amount that is associated with the start time of the PPS signal, the first time and the second time, the second time is represented by a second count value of the local time base counting module, and the second count value is the count value of the local time base counting module when the synchronization correction of system time is performed by the second time correction module.

7. The chip according to claim 6, wherein the second time correction amount is further associated with a second error that comprises a second PPS signal transmission delay, a second PPS signal reception delay, and a first read delay;
wherein the second PPS signal transmission delay is a transmission time of the PPS signal from the on-chip clock subsystem to the global time base counting module;
the second PPS signal reception delay is a time required from the global time base counting subsystem receiving the PPS signal to latching the first time; and
the first read delay is a time required to read the second count value from the local time base counting module.

8. The chip according to claim 6, wherein the global time base counting subsystem further comprises: an encoding module, configured to encode the count value output by the global time base counting module and output an encoding result; and
the second-category subsystem further comprises: a decoding module configured to decode the encoding result to obtain the count value of the global time base counting module.

9. The chip according to claim 2, wherein the other-category subsystem comprises a third-category subsystem, and the third-category subsystem comprises: a third inter-core communication module, a fourth inter-core communication module, and a third time correction module,
wherein the third inter-core communication module is coupled to the on-chip clock subsystem, and is configured to receive second notification information transmitted by the on-chip clock subsystem, wherein the second notification information comprises the start time of the PPS signal and the first time;
the fourth inter-core communication module is coupled to the global time base counting module; and
the third time correction module is configured to perform synchronization correction of its own system time through a third time correction amount that is associated with the start time of the PPS signal, the first time and the second time, wherein the second time is determined by a third count value of the global time base counting module, the third count value is a count value obtained from the global time base counting module through the fourth inter-core communication module when the synchronization correction of system time is performed by the third time correction module.

10. The chip according to claim 9, wherein the third time correction amount is further associated with a third error that comprises a second PPS signal transmission delay, a second PPS signal reception delay, and a second read delay;
wherein the second PPS signal transmission delay is a transmission time of the PPS signal from the on-chip clock subsystem to the global time base counting subsystem;
the second PPS signal reception delay is a time required from the global time base counting subsystem receiving the PPS signal to latching the first time; and
the second read delay is a time required to read the third count value from the global time base counting module.

11. An electronic device, comprising a chip,
wherein the chip comprises: an on-chip clock subsystem, a global time base counting subsystem, and a plurality of subsystems, wherein the plurality of subsystems comprise at least one of the following: a first-category subsystem and an other-category subsystem;
wherein the on-chip clock subsystem is configured to transmit a Pulse Per Second (PPS) signal to the global time base counting subsystem, and output a start time of the PPS signal to the plurality of subsystems;
the global time base counting subsystem is configured to: forward the PPS signal to the first-category subsystem; and/or obtain a first time when the PPS signal is received, and provide a second time for the other-category subsystem to perform synchronization correction of system time;
the first-category subsystem and the other-category subsystem all use the PPS signal as a synchronization trigger source;
the first-category subsystem is configured to perform synchronization correction of its own system time based on the start time of the PPS signal and a first local time when the PPS signal is received, and has the ability to receive the PPS signal; and
the other-category subsystem is configured to perform synchronization correction of its own system time based on the start time of the PPS signal, the first time and the second time.

12. The electronic device according to claim 11, wherein the global time base counting subsystem comprises at least one of the following: a gate module, a local latch module, and a global time base counting module;
wherein the gate module is configured to receive the PPS signal and forward the PPS signal to the first-category subsystem;
the local latch module is configured to latch a first count value, wherein the first count value represents the first time, and the first count value is a count value of the global time base counting module when the global time base counting subsystem receives the PPS signal; and
the global time base counting module is configured to count based on a preset frequency.

13. The electronic device according to claim 11, wherein the first-category subsystem comprises: a PPS receiving module, a first inter-core communication module, and a first time correction module;
wherein the PPS receiving module is configured to receive the PPS signal transmitted by the on-chip clock subsystem and latch the first local time when the PPS signal is received;
the first inter-core communication module is coupled to the on-chip clock subsystem and is configured to receive first notification information transmitted by the on-chip clock subsystem, wherein the first notification information comprises the start time of the PPS signal; and
the first time correction module is configured to perform synchronization correction of its own system time through a first time correction amount that is associated with the first local time and the start time of the PPS signal.

14. The electronic device according to claim 13, wherein the first time correction amount is further associated with a first error that comprises a first PPS signal transmission delay and a first PPS signal reception delay;
wherein the first PPS signal transmission delay is a transmission time of the PPS signal from the on-chip clock subsystem to the first-category subsystem; and
the first PPS signal reception delay is a time required from the PPS receiving module receiving the PPS signal to the PPS receiving module capturing the first local time.

15. The electronic device according to claim 13, wherein the first time correction module is configured to correct its own system time using the first time correction amount in response to the first time correction amount being greater than a preset time threshold; and/or
in response to the first time correction amount being not greater than the preset time threshold, correcting system time of the first-category subsystem in a successive approximation manner with a fixed time step.

16. The electronic device according to claim 12, wherein the other-category subsystem comprises a second-category subsystem, and the second-category subsystem comprises: a second inter-core communication module, a local time base counting module, and a second time correction module;
wherein the second inter-core communication module is coupled to the on-chip clock subsystem and is configured to receive second notification information transmitted by the on-chip clock subsystem, wherein the second notification information comprises the start time of the PPS signal and the first time;
the local time base counting module is coupled to the global time base counting module, and a count value of the local time base counting module is equal to the count value of the global time base counting module; and
the second time correction module is configured to perform synchronization correction of its own system time through a second time correction amount that is associated with the start time of the PPS signal, the first time and the second time, the second time is represented by a second count value of the local time base counting module, and the second count value is the count value of the local time base counting module when the synchronization correction of system time is performed by the second time correction module.

17. The electronic device according to claim 16, wherein the second time correction amount is further associated with a second error that comprises a second PPS signal transmission delay, a second PPS signal reception delay, and a first read delay;
wherein the second PPS signal transmission delay is a transmission time of the PPS signal from the on-chip clock subsystem to the global time base counting module;
the second PPS signal reception delay is a time required from the global time base counting subsystem receiving the PPS signal to latching the first time; and
the first read delay is a time required to read the second count value from the local time base counting module.

18. The electronic device according to claim 16, wherein the global time base counting subsystem further comprises: an encoding module, configured to encode the count value output by the global time base counting module and output an encoding result; and
the second-category subsystem further comprises: a decoding module configured to decode the encoding result to obtain the count value of the global time base counting module.

19. The electronic device according to claim 12, wherein the other-category subsystem comprises a third-category subsystem, and the third-category subsystem comprises: a third inter-core communication module, a fourth inter-core communication module, and a third time correction module,
wherein the third inter-core communication module is coupled to the on-chip clock subsystem, and is configured to receive second notification information transmitted by the on-chip clock subsystem, wherein the second notification information comprises the start time of the PPS signal and the first time;
the fourth inter-core communication module is coupled to the global time base counting module; and
the third time correction module is configured to perform synchronization correction of its own system time through a third time correction amount that is associated with the start time of the PPS signal, the first time and the second time, wherein the second time is determined by a third count value of the global time base counting module, the third count value is a count value obtained from the global time base counting module through the fourth inter-core communication module when the synchronization correction of system time is performed by the third time correction module.

20. The electronic device according to claim 19, wherein the third time correction amount is further associated with a third error that comprises a second PPS signal transmission delay, a second PPS signal reception delay, and a second read delay;
wherein the second PPS signal transmission delay is a transmission time of the PPS signal from the on-chip clock subsystem to the global time base counting subsystem; the second PPS signal reception delay is a time required from the global time base counting subsystem receiving the PPS signal to latching the first time; and
the second read delay is a time required to read the third count value from the global time base counting module.
